(19) United States
(12) Patent Application Publication
(10) Pub. No.: US 2019/0246670 A1
(43) Pub. Date: Aug. 15, 2019

(54) PERMEATION DEVICE FOR BENEFICIAL SUPPLEMENTATION TO GASEOUS ATMOSPHERES IN ENCLOSED VOLUMES

(71) Applicant: University of Florida Research Foundation, Inc., Gainesville, FL (US)

(72) Inventors: Bruce A. WELT, Gainesville, FL (US); Boz Ozdemir ZIYNET, Gainesville, FL (US)

(21) Appl. No.: 16/314,012

(22) PCT Filed: Jul. 17, 2017
(86) PCT No.: PCT/US17/42388

§ 371 Date: Dec. 28, 2018

Related U.S. Application Data
(60) Provisional application No. 62/362,713, filed on Jul. 15, 2016.

(51) Int. Cl. A23L 3/3418; A23L 3/3454; A23L 19/00; A23B 7/148; A23B 7/153

(52) U.S. Cl. CPC A23L 3/3418; A23L 3/3454; A23L 19/03; B60C 23/00; A23B 7/153; A23V 2002/00; A23B 7/148

(57) ABSTRACT

The subject invention provides devices and methods for regulating the composition and pressure of one or more gaseous species and/or volatile chemicals present in a volume enclosed by a flexible, semi-rigid, or rigid packaging material. In one aspect, the subject invention provides a device designed to be inserted into an enclosed volume, the device comprising a predetermined concentration of one or more gaseous species and/or volatile chemicals contained in a capsule comprising packaging materials selected according to the desired composition, pressure or concentration, and rate of permeation of the content of the device. In another aspect, the subject invention provides a method for regulating the atmospheric condition within an enclosed volume, the method comprising inserting the device provided herein into the enclosed volume and allowing the content of the device to permeate into the enclosed volume over a desired period of time.

### CROSS-REFERENCE TO RELATED APPLICATION

This application claims the benefit of U.S. Provisional Application Ser. No. 62/362,713, filed Jul. 15, 2016, the disclosure of which is hereby incorporated by reference in its entirety, including all figures, tables and amino acid or nucleic acid sequences.

### BACKGROUND OF THE INVENTION

Modified atmosphere packaging, or MAP, has been widely adapted as a means of improving the shelf life of various products such as fresh meats and respiring produce. Typically, MAPs are designed to achieve a desired atmosphere by regulating the amount of oxygen, carbon dioxide, and/or nitrogen within each sealed package to slow down the rate of plant respiration and thus increase the quality of the packaged products as a result. Adjustment of the amount of various gaseous species in a sealed MAP can be done by a number of methods including, for example, flushing the package with a specific gas and employing a selectively permeable packaging material to achieve equilibrium atmosphere within the package.

During plant respiration, the rate of carbon dioxide permeation is approximately four to six times that of oxygen, which can lead to gradual deflation of a flexible MAP. Currently available MAPs focus mainly on manipulating the properties of packaging material to control oxygen permeability without addressing the issue of package deflation over time which, if left unattended, can lead to damaged packages during transportation and shortened shelf life during storage. Thus, there remains a need for packaging systems capable of preserving the quality of produce while reducing the cost associated with damaged packages during supply chain distribution.

### BRIEF SUMMARY OF THE INVENTION

The subject invention provides devices and methods for regulating the composition and pressure of one or more gaseous species and/or volatile chemicals present in an environment enclosed by a flexible, semi-rigid, or rigid packaging material.

In one aspect, the subject invention provides a device designed to be inserted into an enclosed volume, the device comprising a predetermined concentration of one or more gaseous species and/or volatile chemicals contained in a sealed capsule comprising packaging materials selected according to the desired composition, pressure (i.e. concentration), and rate of permeation of the content of the device. In preferred embodiments, the device can be used to maintain, supplement, or modify the concentration of gaseous species and/or volatile chemicals in a flexible modified atmosphere package (MAP) in which the device is inserted, whereby desired atmospheric conditions within the package are met for its intended applications.

In another aspect, the subject invention provides a method for regulating the atmospheric condition within an enclosed volume, the method comprising inserting the device provided herein into the enclosed volume and allowing the content of the device to permeate into the enclosed volume over an extended period of time. In preferred embodiments, the enclosed volume can be a flexible MAP used to store foods such as meats, fish, oil, dairy products, and produce, pharmaceutical products, cosmetics, or any other products whose quality may decrease with increased storage time. Additionally, exemplary embodiment of the device can also be used to maintain pressure in inflatable tires that are known to deflate over time. Advantageously, technology provided herein offers opportunities to maintain or improve the shelf life of products commonly packaged using MAPs or other methods.

### BRIEF DESCRIPTION OF THE DRAWINGS

FIG. 1 demonstrates changes in transient oxygen concentration measured in a package comprising an exemplary embodiment of the permeation device for the first experiment dataset.

FIG. 2 demonstrates changes in transient oxygen concentration measured in the package comprising an exemplary embodiment of the permeation device for the second experiment dataset.

FIG. 3 shows the compatibility of the mathematical model developed herein with the experimental results obtained from a package comprising an embodiment of the permeation device.

FIG. 4 shows changes in gas concentration at 4° C. between a package comprising an embodiment of the permeation device and a package without, both also comprising 1 kg of produce with maximum respiration rate and respiratory quotient of 50 cm³h⁻¹kg⁻¹ and 1, respectively. Other parameters of the outer package and the embodiment of the permeation device are as the following: i) the initial O₂, CO₂, and N₂ concentration in the package was 21%, 79% and 0%, respectively; ii) O₂, CO₂ and N₂ transmission rate (OTR) was 2000 cm³m²day⁻¹, 2000 cm³m²day⁻¹, and 10000 cm³m²day⁻¹, respectively; iii) the initial O₂, CO₂ and N₂ concentration in the embodiment of the permeation device was 100%, 0%, and 0%, respectively; iv) O₂, CO₂ and N₂ transmission rate (OTR) of the embodiment of the permeation device was 300 cm³m²day⁻¹, 300 cm³m²day⁻¹, and 1500 cm³m²day⁻¹, respectively.

FIG. 5 demonstrates changes in free volume (i.e., when additional gas is introduced to a full package) or volume fraction (i.e., the ratio of free volume to the maximum free volume) of the flexible packages (i.e., when there is less gas than what is needed to fill the package) comprising 1 kg of produce with and without the use of an embodiment of the permeation device with the same parameters used as those in FIG. 4.

FIG. 6 demonstrates predicted changes in gas concentration at 4° C. between a package comprising an embodiment of the permeation device and a package without, both also comprising 1 kg of strawberries with maximum respiration rate and respiratory quotient of 10 cm³h⁻¹kg⁻¹ and 1, respectively. Other parameters of the outer package and the embodiment of the permeation device are as the following: i) the initial O₂, CO₂ and N₂ concentrations in the package was 21%, 79%, and 0%, respectively; ii) O₂, CO₂, and N₂ transmission rate (OTR) was 2000 cm³m²day⁻¹, 2000 cm³m²day⁻¹, and 10000 cm³m²day⁻¹, respectively; iii) the initial O₂, CO₂ and N₂ concentration in the embodiment of the permeation device was 40%, 50%, and 10%, respectively; iv) O₂, CO₂ and N₂ transmission rate (OTR) of the embodiment of the permeation device was 300 cm³m²day⁻¹, 300 cm³m²day⁻¹, and 1500 cm³m²day⁻¹, respectively.

FIG. 7 is an image of an exemplary embodiment of the permeation device inserted into a sealed flexible package.

FIG. 8 shows an aviation spark plug sealed in LDPE plastic tube.

FIG. 9 shows a fixture used to pressurize prototype devices.

FIG. 10 shows tooling used to create mechanical pressure seals.

FIG. 11 shows examples of prototype permeation devices used in testing.

FIG. 12 shows a computer model and measured headspace data for packages with only prototype device. Prototype device initially charged with 100% oxygen at about 40 psig. Packages initially flushed with nitrogen.

FIG. 13 shows oxygen concentration in packages containing grape tomatoes with and without the prototype device. Ideally, grape tomatoes prefer about 4% oxygen for maximum shelf life.

FIG. 14 shows packages containing very high respiring baby spinach. Ideally, baby spinach prefers >1% oxygen. The prototype device extended preferably conditions by about one day.

FIG. 15 shows packages with and without prototype device containing whole Granny Smith apples.

FIG. 16 shows the prediction of oxygen and carbon dioxide changes for properly specified device for baby spinach application.

### DETAILED DISCLOSURE OF THE INVENTION

The subject invention provides devices and methods for regulating the composition and pressure of one or more gaseous species and/or volatile chemicals present in an environment enclosed by a flexible, semi-rigid, or rigid packaging material.

In one aspect, the subject invention provides a device designed to be inserted into an enclosed volume, the device comprising a predetermined concentration of one or more gaseous species and/or volatile chemicals contained in a sealed capsule comprising packaging materials selected according to the desired composition, pressure (i.e. concentration), and rate of permeation of the content of the device.

The gaseous species can be a pure gas or a mixture of different pure gases. In preferred embodiments, the device comprises one or more gaseous species involved in plant respiration and ripening including, but not limited to, oxygen (O₂), carbon dioxide (CO₂), and ethylene (C₂H₄). Optionally, the device can also comprise inert gases such as, for example, nitrogen (N₂) and noble gases such as, for example, argon (Ar).

The volatile chemicals can be, for example, liquids or solids that can evaporate or sublime from their respective state into the surrounding atmosphere. Non-limiting examples of volatile chemicals include perfumes, deodorants, and anti-microbial compounds.

In some embodiments, the device can be used to maintain or modify composition and concentration of gaseous species within an enclosed volume that can otherwise change over time due to gas permeation into and out of the enclosed volume. In some embodiments, the device can be used to supplement an enclosed volume with one or more gaseous species. In certain embodiments, the device is vacuum-sealed.

In preferred embodiments, the device can be used to maintain, supplement, or modify the composition and concentration of gaseous species in a modified atmosphere package (MAP), whereby desired atmospheric conditions within the package are satisfied for its intended transportation and storage purposes. The device provided herein is particularly advantageous when it is inserted into an MAP designed to store respiring products including, but not limited to, vegetables, fruits, and flowers. Optionally, the MAP can be flushed with an inert gas prior to the insertion of the permeation device. As used herein, an inert gas is a species that does not initiate or participate in chemical and/or biological reactions taking place within the enclosure of the package.

Conventional flexible MAPs are filled with one or more gaseous species to form a pillow-like package prior to transportation such that the fullness of the package can protect its contents from external abuse sustained during the supply chain process. However, since plant respiration simultaneously consumes O₂ and produces CO₂ and CO₂, which is known to permeate 4-6 times faster than O₂, MAPs comprising respiring products tend to deflate over time, causing the packages to appear vacuum-sealed at retail. Advantageously, an exemplary embodiment of the device filled with a fixed concentration of O₂ and an inert gas such as N₂ can be inserted into the MAPs such that the permeation of these gaseous species out of the device can maintain a given atmosphere within the package, control the rate of respiration, and protect the packages from external abuse caused by deflation. Permeation of a gas into an enclosed environment from a device as disclosed herein can be achieved by differences in concentrations as represented by their partial pressure within the device and the enclosed environment. As would be apparent, gases will diffuse between the device and enclosed environment until equilibrium concentrations are achieved regardless of whether a pressure difference or gas concentration difference exists between the two spaces (the device and the enclosed environment).

In some embodiments, the device can be used to supplement an enclosed volume with one or more gaseous species and/or volatile chemicals over a given period of time. Many fruits and vegetables are picked when they are unripe, subsequently kept under conditions that prevent or retard the ripening process during transportation, and ripened shortly before being put on sale. Because C₂H₄ has been known to accelerate the ripening process, many fruits and vegetables (e.g., bananas, tomatoes, avocados, Bartlett pears, kiwis, melons, peppers, and mangos) are commercially ripened by being exposed to C₂H₄ in ripening rooms. If the products have been sealed in packages prior to ripening, packages need to be opened to expose their contents to C₂H₄. Thus, an exemplary embodiment of the invention provides a sealed capsule filled with C₂H₄ and optionally with one or more of other gaseous species such as O₂, N₂, and CO₂, such that the controlled release of C₂H₄ from the device into the package ripens the products during transportation and storage. This practice eliminates the need to subject the products to additional ripening, thus reducing the cost and time required for preparing the products for sale.

MAPs designed for storing fresh meat require that a balance between the amount of CO₂ and O₂ within each package is maintained during transportation to keep the meat free from microbial growth while preserving an aesthetic appearance of the meat for marketing purposes. Specifically, CO₂ can keep the pH of the meat low, thereby inhibiting microbial growth under anaerobic conditions, while O₂ is needed to provide the meat with a fresh color as it is presented on the shelf. Therefore, an embodiment of the device filled with a mixture of CO₂ and O₂ at a predetermined concentration and permeation rate determined by the choice of packaging material of the device can provide sustained release of both gaseous species within the MAP for enhanced storage performance and increased shelf life.

In some embodiments, gaseous species present within an enclosed volume can also permeate into an exemplary permeation device that is void of any gaseous species, i.e., comprises vacuum. Specifically, when the vacuum-packed permeation device is placed into the enclosed volume, gaseous species already present within the enclosed volume diffuses from where the pressure/concentration of the gaseous species is higher, e.g., without the device, into where it is lower, e.g., within the device. Advantageously, the vacuum-filled permeation device provided herein can be used to sequester any excessive or undesirable gaseous species such as, for example, CO₂ produced as a result of plant respiration and/or excessive C₂H₄ capable of triggering early ripening of vegetables and fruits within an MAP package. Note that the extent of gas sequestering by the vacuum-packed permeation device and the rate of permeation into the device can be readily controlled by selecting packaging materials in accordance with, for example, the content of the package, the type of gaseous species to be regulated, and the specific storage and transportation processes required.

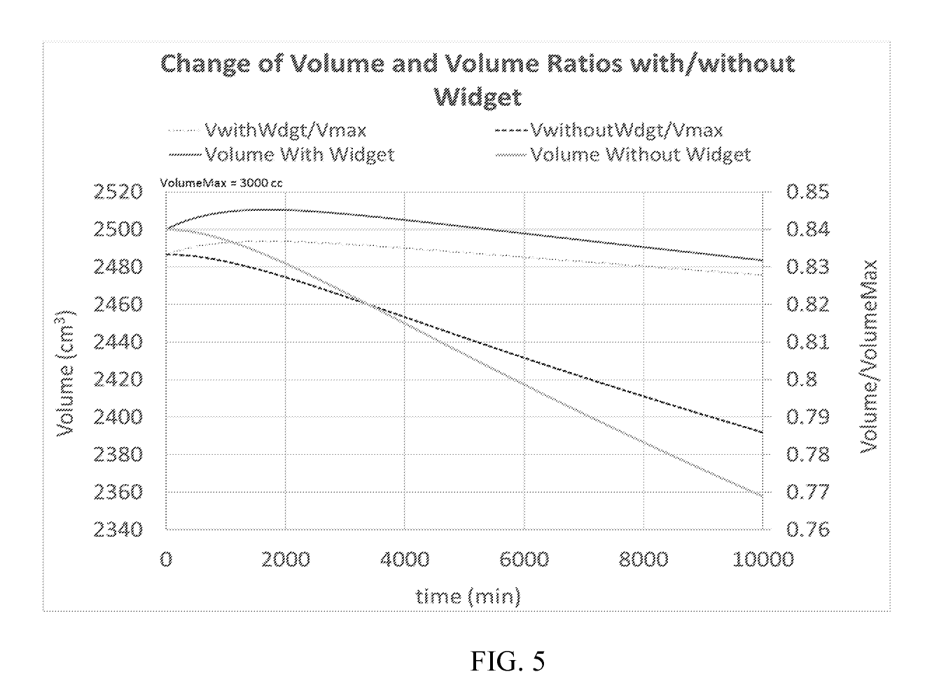

In another aspect, the subject invention provides a device capable of maintaining the package volume (for flexible packages or enclosures) or pressure (for rigid or semi-rigid packages or enclosures). Changes in gas pressure with and without the use of an exemplary embodiment of the device are given in FIG. 5. In a flexible package that is initially full, additional gas permeating out of the device increases gas pressure within the package, keeping the volume of the package full. In the absence of a device as disclosed herein, gas gradually permeates out of the package to keep the package's internal pressure at approximately 1 atm; thus, the gas volume within the package decreases. FIG. 5 shows package pressure (pressure >=1 atm) or package volume fraction (volume <=1) of equivalent flexible packages with and without the disclosed device. It is evident in FIG. 5 that the permeation device provided herein helps to mitigate loss of package volume over time.

Similarly, exemplary embodiment of the device can also be used to maintain pressure in inflatable tires that are known to deflate over time. Much work has been done to develop low-permeation tire materials to slow down the deflation process, but the issue remains significant. Underinflated tires are a primary cause of premature wear, poor gas mileage, unnecessary carbon emissions, and tire failure. Insertion into a tire of a device designed to have approximately the same gas delivery rate to the tire as the rate at which gas is lost from the tire can help maintain the recommended tire pressures for much longer periods of time than what will be achieved by modification of tire materials alone.

The device provided herein regulates the atmospheric conditions within an enclosed volume by way of molecular permeation of gaseous species out of the device into the enclosed volume. Thus, in instances where the absolute pressures of the device and the enclosed volumes are equal, permeation of a gas from the device into the enclosed volume (or vice versa) can be achieved where the concentration of a gas differs between the device and the enclosed volume or where the pressure of a gas differs between the device and the enclosed volume. Alternatively, gaseous species already present in the enclosed volume can also permeate into the device by way of molecular permeation. Absolute rates of permeation from the device to the enclosed environment in which it is inserted are determined by parameters such as material permeability coefficient and package film thickness, as well as the composition and concentration (i.e. the partial pressure) of the gaseous species and/or volatile chemicals present in the device.

As a non-limiting example, dynamics of gas exchange in a sealed MAP designed to store respiring produce comprising an embodiment of the permeation device can be predicted based on material balances using computer models. Exemplary mass balance equations (equations (1)-(3)) are as follows:

dn_{O}_{₂}^{pkg}=dn_{O}_{₂}^{app}−dn_{O}_{₂}^{pa}−dn_{O}_{₂}^{resp} (1)

dn_{N}_{₂}^{pkg}=dn_{N}_{₂}^{app}−dn_{N}_{₂}^{pa} (2)

dn_{CO}_{₂}^{pkg}=dn_{CO}_{₂}^{app}+dn_{CO}_{₂}^{pa} (3)

where dn_{O}_{₂}^{pkg}, dn_{N}_{₂}^{pkg} and dn_{CO}_{₂}^{pkg} represent changes in the concentration of O₂, N₂, and CO₂, respectively, in the package. Superscripts “app,” “pa,” and “resp” indicate the transfer of the gaseous species from the device to the package, from the package to the surrounding atmosphere, and out of the produce as a result of the respiration process, respectively. Gas permeation through the packaging material of the device is expressed in equations (4)-(6) derived from diffusion equation for O₂, CO₂, and N₂, respectively. Numerical solutions of these equations obtained by using the Euler method can predict changes in gas concentration inside the package and the device, respectively.

$$\begin{matrix}\frac{{dn}_{{O}_{2}}^{pkg}}{dt} = \frac{{P}_{{O}_{2}} A}{x} ( {p}_{{O}_{2}}^{ext} - {p}_{{O}_{2}}^{pkg} ) & ( 4 ) \\ \frac{{dn}_{{CO}_{2}}^{pkg}}{dt} = \frac{{P}_{{CO}_{2}} A}{x} ( {p}_{{CO}_{2}}^{ext} - {p}_{{CO}_{2}}^{pkg} ) & ( 5 ) \\ \frac{{dn}_{{N}_{2}}^{pkg}}{dt} = \frac{{P}_{{N}_{2}} A}{x} ( {p}_{{N}_{2}}^{ext} - {p}_{{N}_{2}}^{pkg} ) & ( 6 )\end{matrix}$$

Incorporating the device provided herein affects the concentration of O₂, CO₂, and N₂, respectively, to the extent that depends on the initial concentrations of the gaseous species and the properties of the package materials.

Specific changes in volume and pressure within the enclosed environment are governed by the type of packaging material used to construct both the permeation device and the enclosed environment into which it is inserted. In some embodiments, the device can be flexible, semi-rigid, or rigid, and comprise one or more of the following materials: low-density polyethylene (e.g., LDPE, LLDPE, and metallocene polyethylene), high-density polyethylene (HDPE), medium-density polyethylene, polypropylene (e.g., PP, cast or bi-oriented), polyvinyl chloride (PVC), polyvinylidene chloride (PVdC), polyamides (PA), polystyrene (e.g., crystal- or high-impact polystyrene), polyethylene terephthalate (PET), and polylactic acid (PLA). Those skilled in the art will understand that other gas barrier materials having suitable oxygen transmission rate (OTR), nitrogen transmission rate (NTR), and/or carbon dioxide transmission rate (CO₂TR) may also be used to construct the permeation device and the outer enclosed environment provided herein. In some embodiments, the materials employed for the permeation device and the outer enclosed environment can be the same or different. For example, in the case of a device designed for maintaining the pressure of an inflatable tire, the permeation device can be constructed using a material provided herein while the inflatable tire comprises primarily synthetic and/or rubber materials with minimal gas permeability. In an exemplary embodiment, the OTR of the packaging material of the outer package is two orders of magnitude that of the OTR of the packaging material of the permeation device.

In another aspect, the subject invention provides a method for regulating the atmospheric condition within an enclosed volume, the method comprising inserting the device provided herein such as, for example, a sealed capsule filled with one or more gaseous species, into the enclosed volume and allowing the content of the device to permeate into the enclosed volume over an extended period of time.

Advantageously, technology provided herein reduces the requirement of packaging materials necessary for gas permeation, permitting selection of potentially more desirable materials for specific qualities such as, for example, better puncture resistance, better printing quality, greater tensile strength, and lower static electricity generated during web unwinding, all of which are sought after in a variety of packaging applications.

All patents, patent applications, provisional applications, and publications referred to or cited herein are incorporated by reference in their entirety, including all figures and tables, to the extent they are not inconsistent with the explicit teachings of this specification.

Following are examples which illustrate procedures for practicing the invention. These examples should not be construed as limiting. All percentages are by weight and all solvent mixture proportions are by volume unless otherwise noted. Unless otherwise noted, the oxygen transmission rate (ORT) through the thickness of the packaging materials employed by the permeation device was measured using a dynamic accumulation method according to the ASTM F3136-15 procedures. Measurements were done at least in triplicate and repeated twice.

### EXAMPLE 1

Exemplary permeation devices constructed in the form of polyethylene tubes measuring 1″ in diameter and 0.060″ in thickness were obtained and the OTR of the tube material was determined to be approximately 300 mL/m²/day. Tubes were enriched with oxygen at elevated pressure using two methods. The first method was to seal one side of the tube that was approximately 1 m in length. The opposite side was fixed with a No. 6 rubber stopper, cored to accept ⅛″ OD stainless steel tubing that was connected to a pressure regulated O₂ tank. Individual sample tubes were sealed under pressure in 4″-6″ lengths with pressurized gas. The second method was to seal the tubes in air at atmospheric pressure and then place the tubes into a pressure vessel. The vessel was pressurized to 300-350 psi. Gas permeation resulted in pressurization of the tubes at atmospheric pressure when removed from the pressure vessel.

### EXAMPLE 2

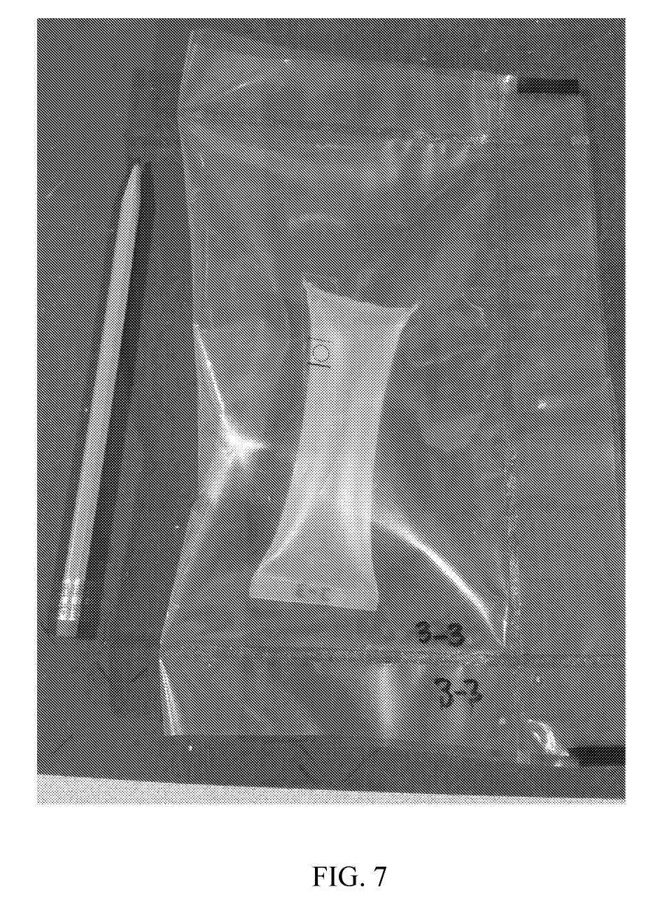

Individual devices were created from low-density polyethylene (LDPE) tubing with known volume and sealed under pressure with 20 psi of O₂-N₂ gas mixture at a known concentration according to the second approach described in EXAMPLE 1. Devices were placed in flexible gas barrier bags with a known OTR of 1 mL/m²/day, measured at 23° C. and normalized to 1 atm partial pressure difference (FIG. 7). Bags with devices were sealed in air at atmospheric pressure. The concentration of O₂ within each package was expected to increase due to permeation of O₂ from the device into the package. Additionally, package volume was expected to increase since the bags offered good barrier to gas transfer. The concentration of O₂ was measured using a non-invasive and non-destructive fluorescence quenching technique.

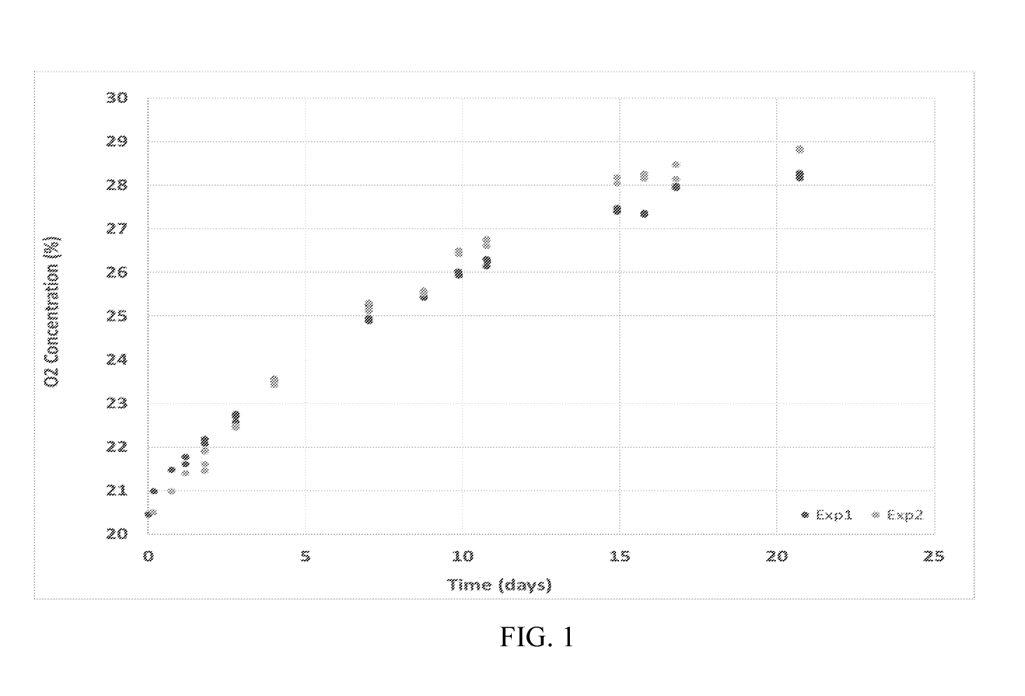

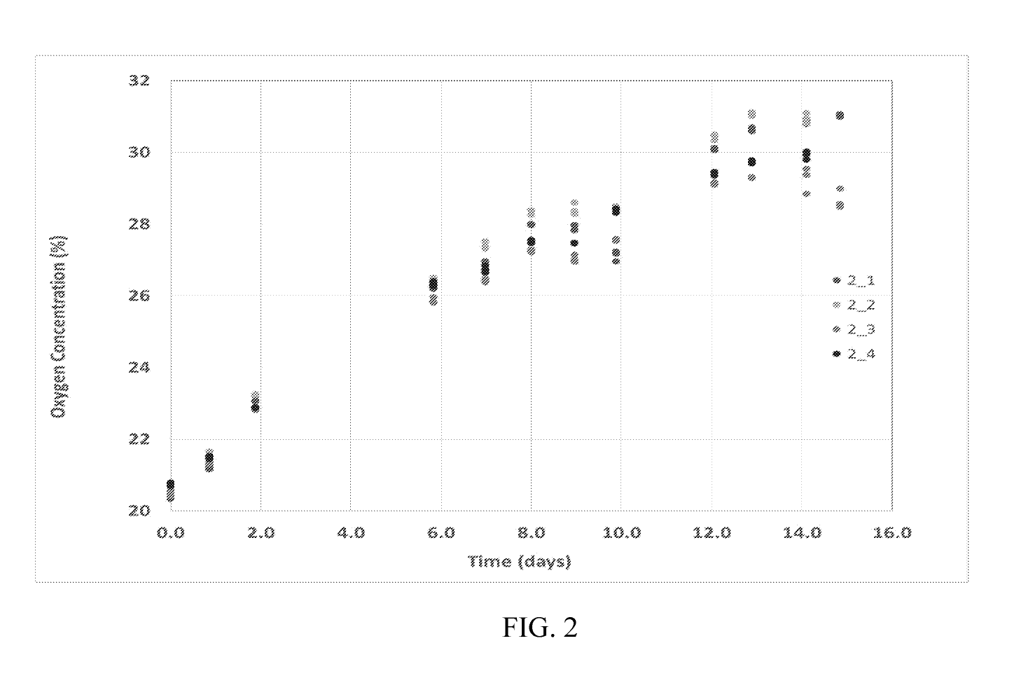

Changes in O₂ concentration in the packages are shown in FIGS. 1 and 2, each representing an experimental dataset. These results show a steady rise in O₂ concentration over a 20-day period. Additionally, while not quantitatively measured, package volumes were observed to be increasing over the same time period. To the extent that a specific amount of respiring produce was introduced into the package such that the respiration rate, as defined by rate of O₂ consumption, matched the rate at which the device delivered O₂, O₂ concentration would remain relatively constant throughout. Further, since respiration converts O₂ to CO₂ and CO₂ tends to permeate much faster than O₂, package volume would be expected to remain more constant over the same time period.

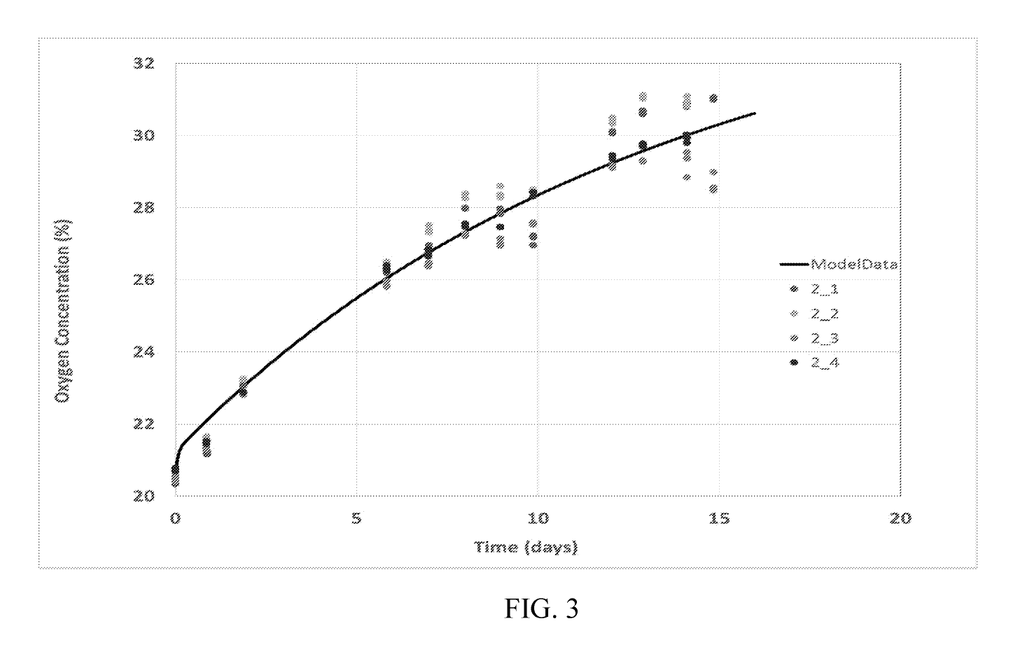

Dynamic gas changes in an empty flexible package, as was done in the experiment, were predicted using a computer model. FIG. 3 shows the comparison of mathematical model with the experimental results.

### EXAMPLE 3

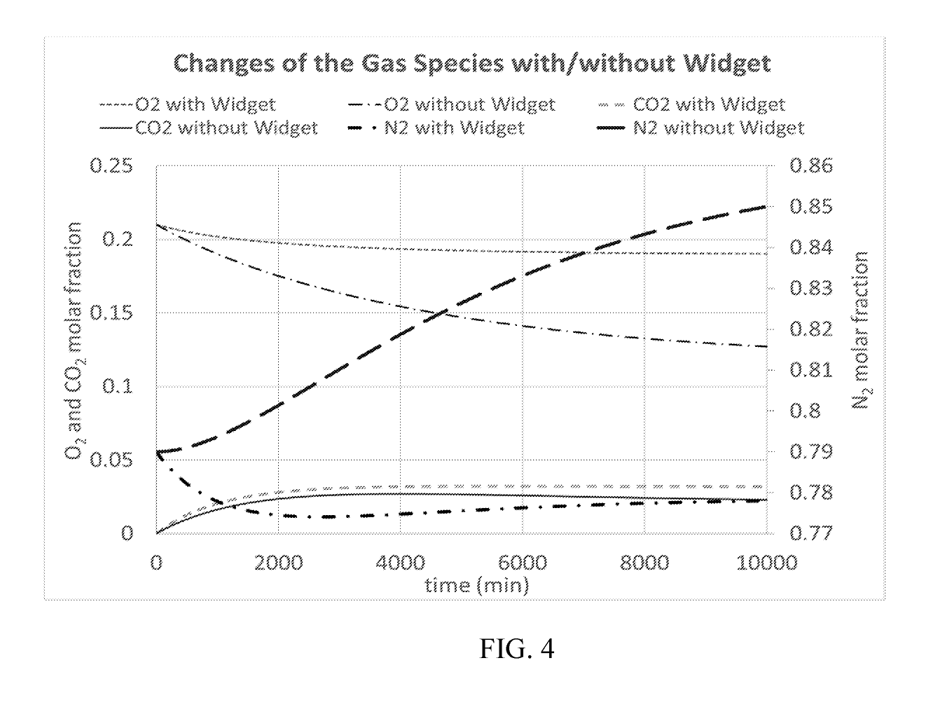

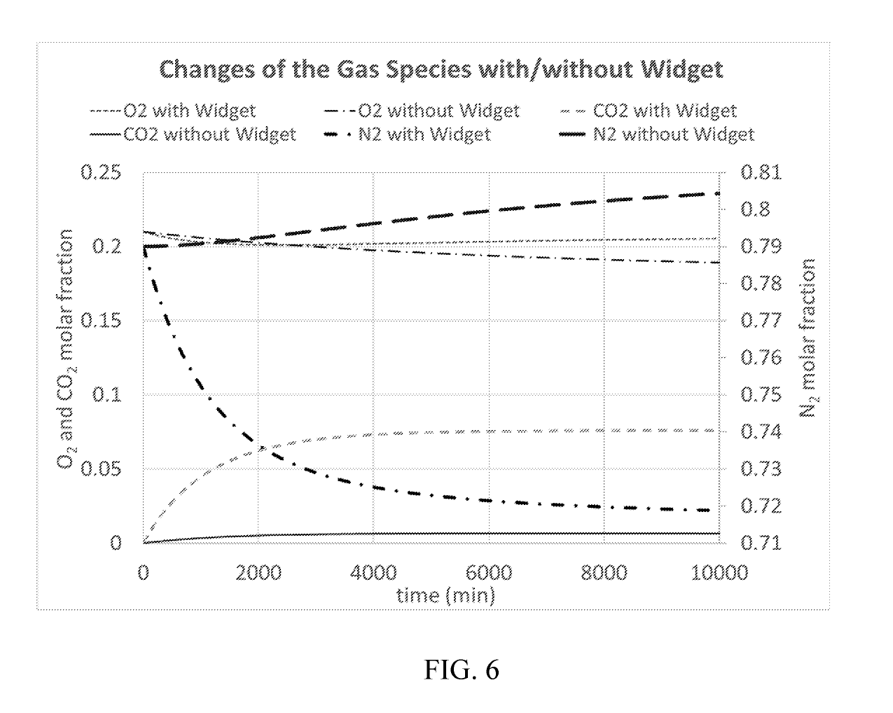

When produce was introduced into packages that each comprises an embodiment of the permeation device, concentration of O₂ remained constant. This was shown by incorporating produce properties to the simulation model. Effects of using an embodiment of the permeation device in a package comprising 1 kg of produce are shown in FIGS. 4-6. The mathematical model was solved for produce with certain physio-chemical properties and the changes in concentrations of O₂, CO₂, and N₂ in the package were demonstrated in FIG. 4. Comparison of the free volume changes in the same flexible package were given in FIG. 5. Actual volume and volume ratio parameters were used to compare the packages with and without the exemplary permeation device as the volume ratio was equal to the ratio of free volume at time t to maximum volume when the package is completely full. Therefore, the volume ratio for a flexible package that is 100% full with gas at 1 atm in external pressure equals to 1. Without the permeation device, O₂ concentration dropped from 21% to 15% after 3 days of storage. By using the device (“widget” in FIGS. 4-6), it was kept above 18% for the entire storage time of 10000 minutes, or approximately 7 days. However, if the low initial O₂ concentrations were used, harmful anaerobic conditions that could lead to the development of off-odors and off-flavors can easily be reached. FIG. 6 shows changes in gas concentration in the package filled with strawberries that have lower respiration rates and higher optimum CO₂ requirements. The initial concentration of atmospheric O₂ was preserved and the required CO₂ concentrations were obtained during 7 days of storage with the exemplary permeation device used for lower respiration rate produce.

### EXAMPLE 4

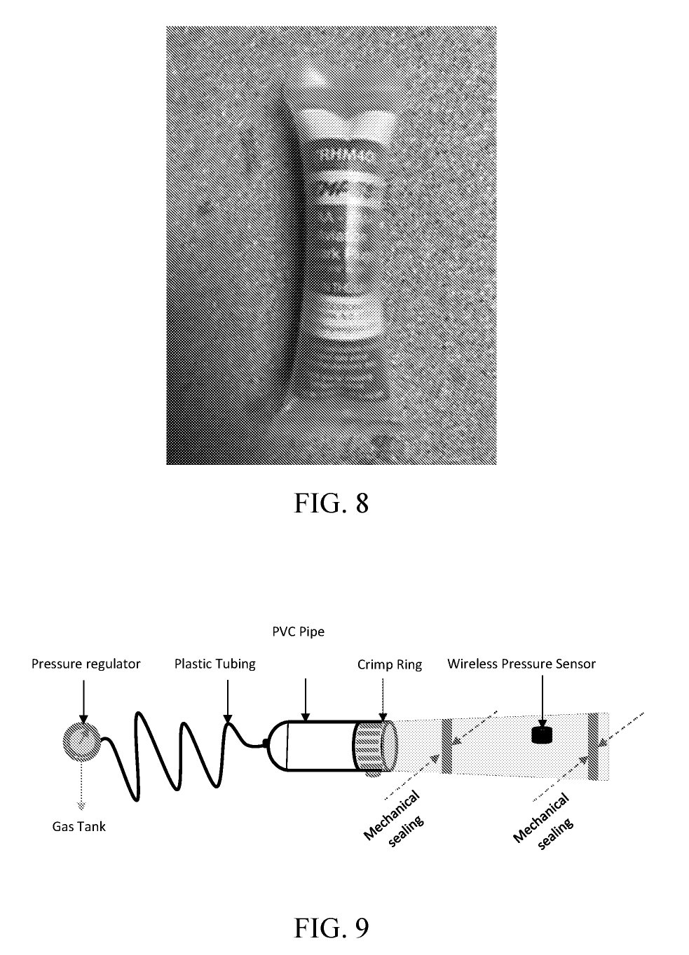

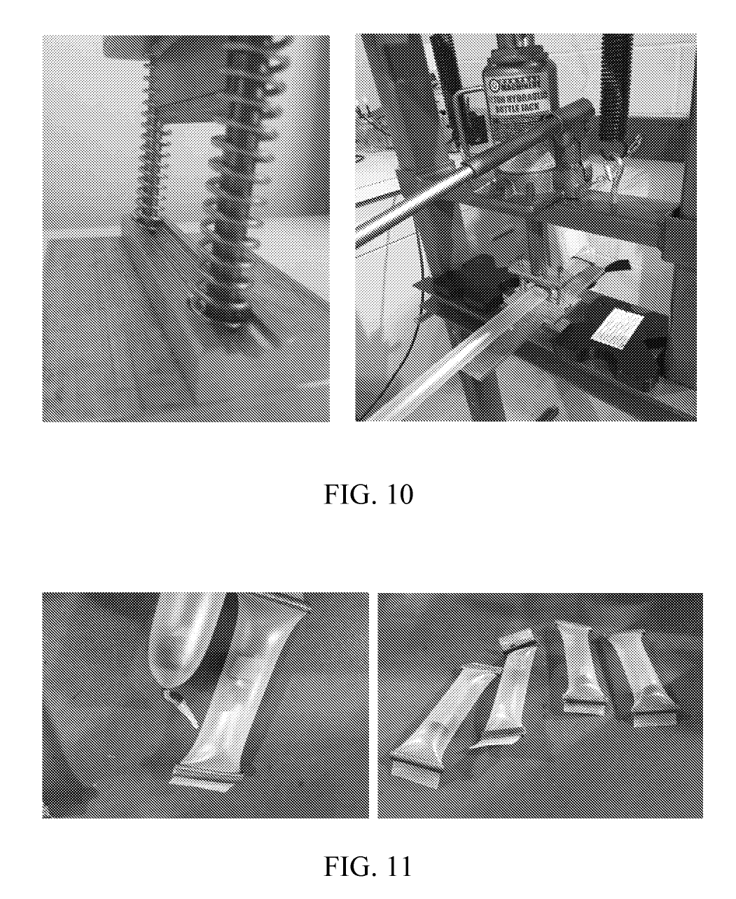

Functional prototypes of the device were fabricated from 1″ diameter LDPE tubing that is often used for packaging aviation spark plugs (FIG. 8).

Eight foot lengths of tubing were procured from a spark plug manufacturer supplier for this work. Permeable prototype devices were made using a rigid PVC pipe fixture that was connected to a regulated gas source (FIG. 9). It was determined that this tube material was capable of being pressurized to about 60 psig before rupturing. Therefore, this work was performed with initial internal pressures of about 40 psig. Wireless pressure sensors were inserted into prototypes during fabrication in order to monitor gas permeation progress during testing.

For these tests, a metal mechanical seal was used by crushing a 1″ copper crimp rig over tubes at appropriate locations while tubes were pressurized with regulated air. A 12 ton hydraulic press was used in conjunction with a specialized tool for bending crimp rings (FIG. 2). The resulting prototypes are shown in FIG. 11.

### Results and Discussion

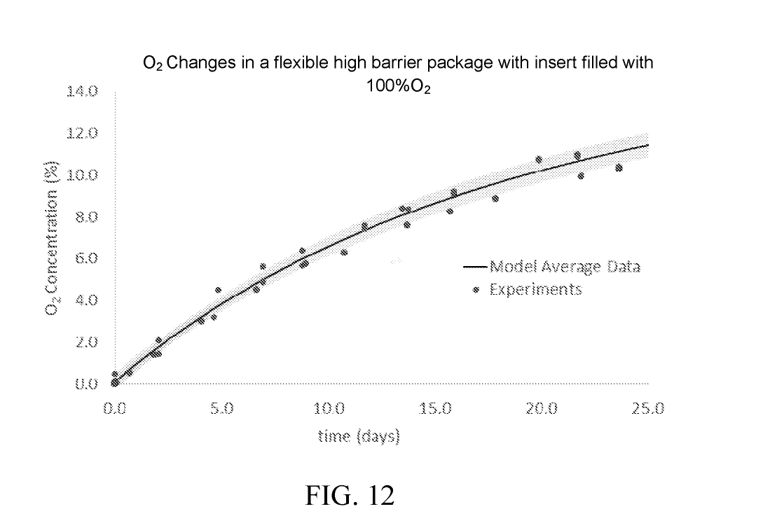

Initially, empty packages were charged with the pressured permeable prototypes and headspace gas was monitored. A computer model was developed in order to predict package headspace gas dynamics over time. FIG. 12 shows model predictions versus experimental data over time.

Additional tests were performed with packages filled with respiring produce. Headspace gas for packages with and without the prototype device were monitored. As would be apparent to those skilled in the art, this technology can be optimized for specific applications. While the device used in this test was not optimized for a particular application, it clearly demonstrated proof of concept and showed differences between packages with and without a gas permeable pressurized device.

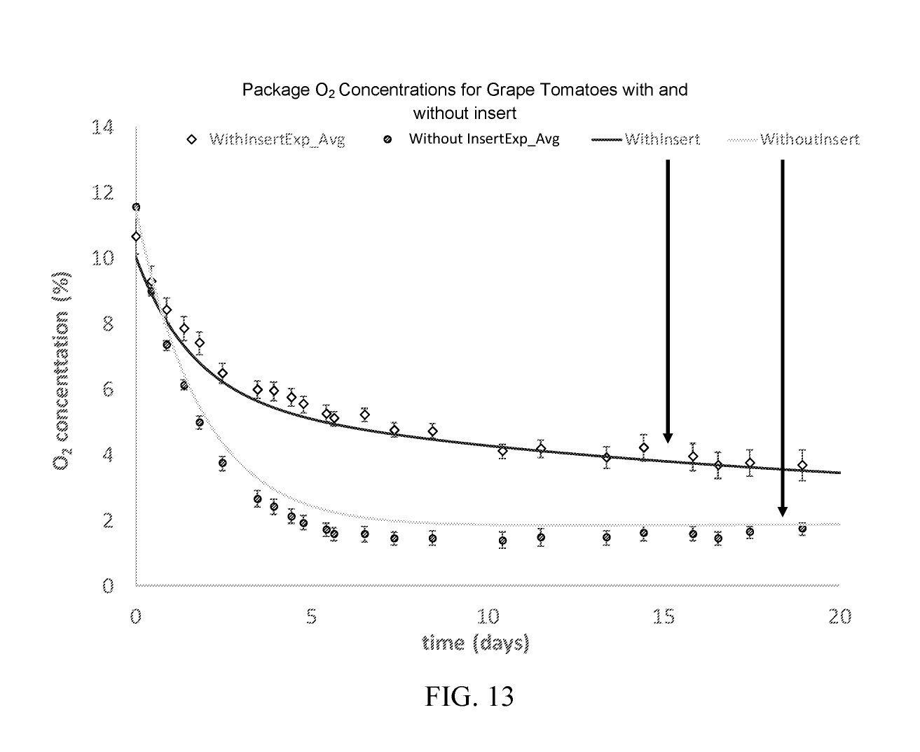

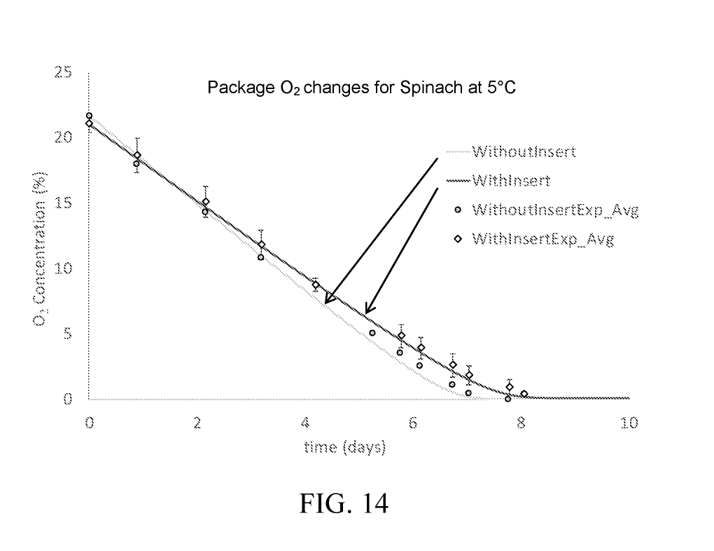

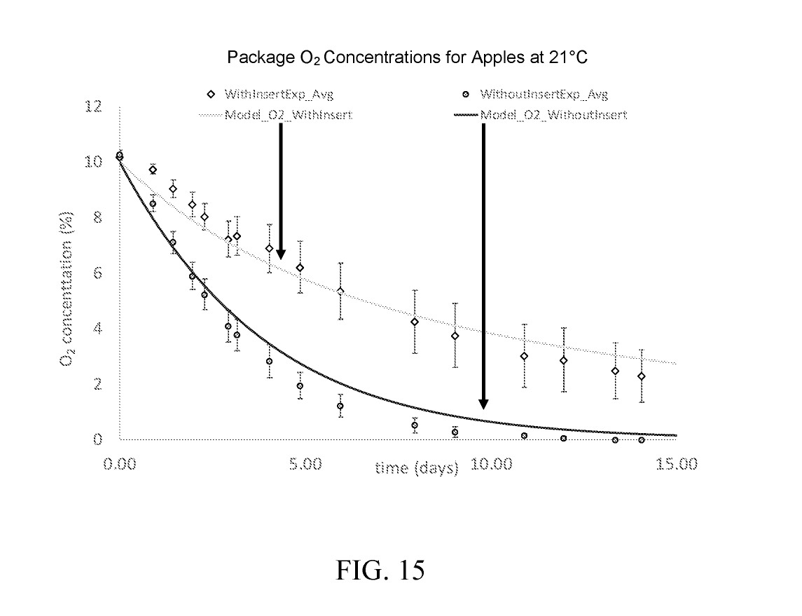

The results show that the prototype device either successfully maintained a beneficial atmosphere over a reasonable distribution life for packages containing grape tomatoes (>4% O₂, FIG. 13) or improved the atmosphere relative to packages without the device for packages containing baby spinach (FIG. 14). Baby spinach is known to have a very high respiration rate, therefore, a pressurized gas permeable device with a high permeability rate would be desirable for such an application. Devices with high gas permeability rates can be designed with higher device pressures, device materials with higher permeation coefficients, thinner wall thicknesses and/or greater permeation transfer areas. Additional work was done with whole apples and is illustrated in FIG. 15.

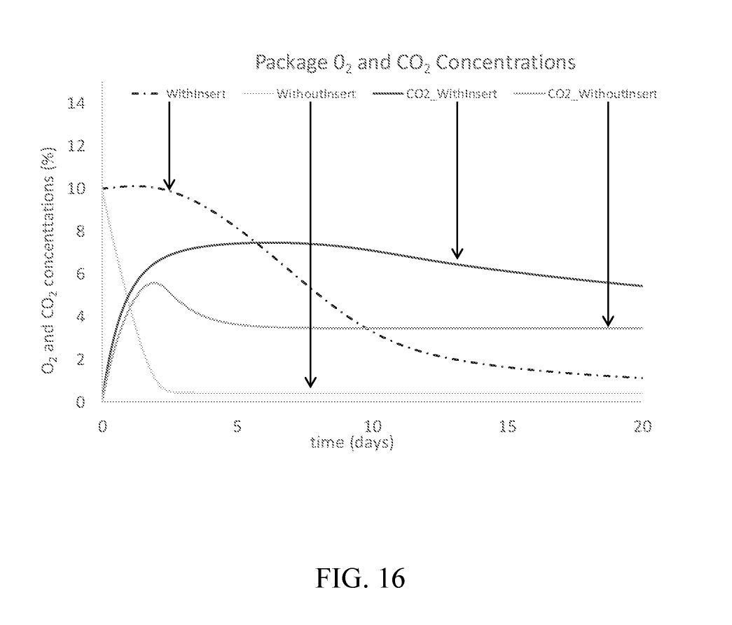

These results validate our computer model for predicting dynamic gas behavior within packages which has been used to predict oxygen and carbon dioxide exchange in a device for containerizing baby spinach (FIG. 16).

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated within the scope of the invention without limitation thereto.

We claim:

1. A device for regulating the atmospheric conditions in an enclosed environment, comprising a sealed capsule filled with a predetermined concentration of at least one chemical species, wherein the sealed capsule comprises one or more packaging material selected according to the desired composition, concentration, and rate of permeation of the at least one chemical species contained in the sealed capsule and an enclosed environment.

2. The device according to claim 1, wherein the at least one chemical species contained in the sealed capsule is selected from a gaseous species, a volatile liquid, a volatile solid, and a combination thereof.

3. The device according to claim 1, wherein the enclosed environment is a modified atmosphere package used for storing products selected from meats, fish, oil, vegetables, fruits, flowers, dairy products, pharmaceutical products, and cosmetics.

4. The device according to claim 3, wherein the sealed capsule is filled with a predetermined concentration of one or more gaseous species selected from oxygen, carbon dioxide, nitrogen, and ethylene.

5. The device according to claim 1, wherein the enclosed environment is an inflatable tire.

6. The device according to claim 1, wherein the sealed capsule comprises one or more packaging materials selected from low-density polyethylene, linear low-density polyethylene, metallocene polyethylene, medium-density polyethylene, high-density polyethylene, cast polypropylene, bi-oriented polypropylene, polyvinyl chloride, polyvinylidene chloride, polyamides, polystyrene, high-impact polystyrene, polyethylene terephthalate and polylactic acid.

7. The device according to claim 6, wherein said modified atmosphere package contains a meat, fish, oil, vegetable, fruit, flower, dairy product, pharmaceutical product or cosmetic.

8. A method for regulating the atmospheric conditions in an enclosed environment, comprising:
inserting into the enclosed environment a sealed capsule filled with a predetermined concentration of at least one chemical species, wherein the sealed capsule comprises one or more packaging material selected according to the desired composition, concentration, and rate of permeation of the at least one chemical species contained in the sealed capsule; and
allowing the content of the sealed capsule to permeate into the enclosed environment over an extended period of time.

9. The method according to claim 8, wherein the at least one chemical species contained in the sealed capsule is selected from a gaseous species, a volatile liquid, a volatile solid, and a combination thereof.

10. The method according to claim 8, wherein the enclosed environment is a modified atmosphere package used for storing products selected from meats, fish, oil, vegetables, fruits, flowers, dairy products, pharmaceutical products, and cosmetics.

11. The method according to claim 10, wherein the sealed capsule is filled with a predetermined concentration of one or more gaseous species selected from oxygen, carbon dioxide, nitrogen, and ethylene.

12. The method according to claim 8, wherein the enclosed environment is an inflatable tire.

13. The method according to claim 8, wherein the sealed capsule comprises one or more packaging materials selected from low-density polyethylene, linear low-density polyethylene, metallocene polyethylene, medium-density polyethylene, high-density polyethylene, cast polypropylene, bi-oriented polypropylene, polyvinyl chloride, polyvinylidene chloride, polyamides, polystyrene, high-impact polystyrene, polyethylene terephthalate, and polylactic acid.

14. A method for regulating the atmospheric conditions in a modified atmosphere package (MAP), comprising:
inserting into the MAP a sealed capsule filled with a predetermined concentration of at least one gaseous species, wherein the sealed capsule comprises one or more packaging material selected according to the desired composition, concentration, and rate of permeation of the at least one gaseous species contained in the sealed capsule; and
allowing the content of the sealed capsule to permeate into the MAP over an extended period of time.

15. The method according to claim 14, wherein the MAP is used for storing products selected from meats, fish, oil, vegetables, fruits, flowers, dairy products, pharmaceutical products, and cosmetics.

16. The method according to claim 15, wherein the sealed capsule is filled with a predetermined concentration of one or more gaseous species selected from oxygen, carbon dioxide, nitrogen, and ethylene.

17. The method according to claim 14, wherein the sealed capsule comprises one or more packaging materials selected from low-density polyethylene, linear low-density polyethylene, metallocene polyethylene, medium-density polyethylene, high-density polyethylene, cast polypropylene, bi-oriented polypropylene, polyvinyl chloride, polyvinylidene chloride, polyamides, polystyrene, high-impact polystyrene, polyethylene terephthalate, and polylactic acid.
